(19) United States
(12) Patent Application Publication
(10) Pub. No.: US 2005/0252730 A1
(43) Pub. Date: Nov. 17, 2005

(54) Wheel hub

(76) Inventor: Ernst Auer, Muenchen (DE)

Correspondence Address: WOMBLE CARLYLE SANDRIDGE & RICE, PLLC, P.O. BOX 7037, ATLANTA, GA, 30357-0037, US

(21) Appl. No.: 11/126,616

(22) Filed: May 11, 2005

Related U.S. Application Data
(60) Provisional application No. 60/571,989, filed on May 18, 2004.

(30) Foreign Application Priority Data
May 14, 2004 (EP) 04011519.8

(51) Int. Cl. F16D 55/36

(52) U.S. Cl. 188/71.5

(57) ABSTRACT

The present invention relates to a wheel hub for an axle of a motor vehicle or truck, especially for axles of construction-site trucks and off-road vehicles or tipping trucks, including a multi-disk brake consisting of plural disk-shaped outer plates and corresponding disk-shaped inner plates as well as an outer hub and a brake housing, which form an encapsulated housing with a space for the multi-disk brake, wherein the encapsulated housing is formed in the interior such that circulation of cooling fluid located therein occurs in the space. Therein, the outer hub has an at least partially surrounding collar projecting outwardly of the outer hub, wherein plural openings for respectively receiving a wheel bolt for connecting the outer hub to a rim of a wheel are formed in the region of the collar. Further a clearance improving the circulation of the cooling fluid is provided in the space between the outer plates and the outer hub.

### CROSS-REFERENCE TO RELATED APPLICATIONS

This application claims convention priority from European patent application no. 04 011 519.8, with a filing date of May 14, 2004. This application also claims the benefit of U.S. provisional patent application No. 60/571,989, with a filing date of May 18, 2004 The specifications and drawings of European patent application no. 04 011 519.8 and of U.S. provisional patent application No. 60/571,989 are specifically hereby incorporated herein by reference.

### BACKGROUND OF THE INVENTION

The present invention relates to a wheel hub for an axle of a motor vehicle or truck, especially for axles of construction-site trucks and off-road vehicles or tipping trucks, including a multi-disk brake consisting of plural disk-shaped outer plates and corresponding disk-shaped inner plates as well as an outer hub and a brake housing, forming an encapsulated housing with a space for the multi-disk brake, wherein the encapsulated housing is formed in the interior such that circulation of cooling fluid located therein occurs in the space.

Such wheel hubs are known. Especially, from DE 196 24 288 C1, an axle for a wheel dredger having a multi-disk brake in the wheel hub is known, which has the above-mentioned characteristics. However, the wheel hub described there is disadvantageous in that the used multi-disk brake is not adapted to higher velocities. In wheel dredges, this does not result in a problem, since they move only with very low velocities. However, with higher velocities, higher braking moment is required. In multi-disk brakes, this can only be achieved by a higher number of plates. However, the higher the number of plates, the higher also the temperatures within the multi-disk brake or the cooling fluid surrounding the multi-disk brake, respectively, particularly arising in idling or in the unbraked state, respectively. Up to now, this problem has only be solved inadequately.

### SUMMARY OF THE INVENTION

At least one object of the present invention is to provide a wheel hub with a multi-disk brake of the initially mentioned type, wherein the multi-disk brake develops only very little temperature especially in idling or in the unbraked state, respectively.

In a wheel hub according to at least one exemplary embodiment of the invention for an axle of a motor vehicle or truck, especially for axles of construction-site trucks and off-road vehicles or tipping trucks, the used multi-disk brake is comprised of plural disk-shaped outer plates and corresponding disk-shaped inner plates as well as an outer hub and a brake housing forming together an encapsulated housing with a space for the multi-disk brake, wherein the encapsulated housing is formed in the interior such that circulation of a cooling fluid located therein occurs in the space. Therein, the outer hub has an at least partially surrounding collar projecting outwardly of the outer hub, wherein plural openings for respectively receiving a wheel bolt for connecting the outer hub to a rim of a wheel are formed in the region of the collar. By this construction according to the invention it is possible to significantly increase the available space for the multi-disk brake. Especially, the wheel bolts no longer protrude into the hub housing, as is the case in the prior art, but are located outside of the hub housing. By increasing this clearance, improved circulation of the cooling fluid, especially oil, located in the space is achieved. Compared to the multi-disk brakes known up to now, temperature decrease of ca. 10 to 25° C. in idle mode or unbraked state, respectively, results. By these low idle temperatures, additionally, it is no longer required to provide additional cooling for the multi-disk brake. Compared to conventional disk brakes, the multi-disk brake is largely free from maintenance, since no wear occurs. Especially, no braking dust arises. Further, the multi-disk brake is guided in the cooling fluid, especially oil. Since the specific heat absorption of the oil is several times higher than with iron, with the same weight, remarkably higher thermal capacity results compared to a known disk brake of iron. Thereby, the wheel hub according to the invention can be designed smaller and more lightweight as a whole.

In an advantageous development of the wheel hub according to the invention, the inner plates constitute the fixed portion and the outer plates constitute the rotating portion of the multi-disk brake, wherein the inner plates are connected to a fixed inner hub through a support member in rotationally fixed and axially displaceable manner, and the outer plates are connected to the radially outward, rotating outer hub in rotationally fixed and axially displaceable manner. Therein, the outer plates have radially outward recesses, which engage with plural bolts axially attached between outer hub and brake housing. Thereby it is ensured that the outer plates are formed in rotationally fixed, but axially displaceable manner, and move reliably together with the rotating brake housing and the outer hub.

In another advantageous development of the invention, for the cooling fluid circulation, a distribution space is formed between an inner side of the brake housing and the bolts. Additionally, it is possible that blade-like devices are peripherally formed between the inner plates and the inner side of the brake housing, wherein the cooling fluid is pressed outwardly into the distributor space by the rotation of the blade-like devices, and flows back again between the outer and inner plates. Such a design of the interior of the brake housing ensures continuous circulation of the cooling fluid through and across all of the heat developing elements and corresponding heat dissipation.

In another advantageous development of the wheel hub according to the invention, the inner plates and/or the outer plates are provided with grooves on one side and/or both sides. Thereby, it is ensured that turbulences of the cooling fluid flowing between the outer and inner plates are largely avoided. The friction between the plate disks decreases, the development of heat is further decreased with not actuated brake.

In another advantageous development of the invention, only the fixed inner plates are provided with a braking-promoting lining. It has turned out that such a design of the inner plates is also advantageous for the development of heat within the multi-disk brake. Especially, it has been determined that the outer plates drive a relatively high volume of cooling fluid or oil, respectively, if they are also provided with a braking-promoting lining, thereby high frictional forces and thus very great development of heat occurring with high velocities. In previous wheel hubs with integrated multi-disk brake, this problem did not arise, since the corresponding wheel dredges have maximum velocities of merely up to 20 km/h with 100 rpm. With higher velocities, such as with 50 km/h, already 180 rpm arise.

In another advantageous development of the invention, a pressurized piston moves a brake plate acting on a first inner plate, wherein a spring pack is disposed in the piston, which supports itself on an inner side of the piston on the one hand and on a thrust plate supported on the inner hub on the other hand, such that the spring pack tensions upon pressurization of the piston and releases the tension upon pressure release. Additionally, the brake plate can be connected to a brake cylinder through a tension spring. Thereby, reliable piston return is ensured.

### BRIEF DESCRIPTION OF THE DRAWINGS

Further details, features and advantages of the invention result from the following description of an embodiment schematically illustrated in the figures.

There Show

FIG. 1 a sectional view of the wheel hub according to the invention; and

FIG. 2 a top view of a sub-portion of the wheel hub according to the invention.

### DETAILED DESCRIPTION OF THE PREFERRED EMBODIMENT

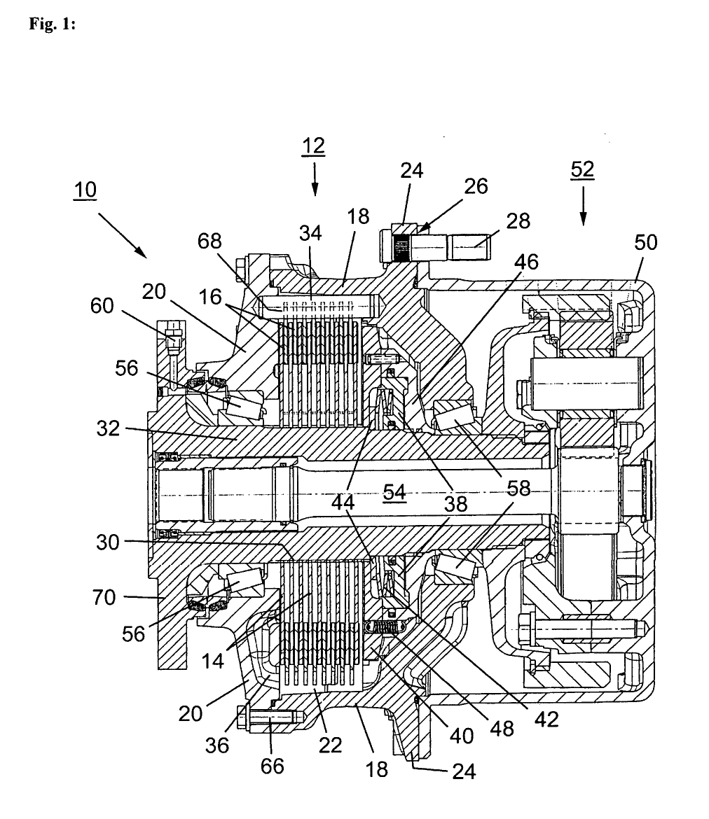

FIG. 1 shows a sectional view of an embodiment of the wheel hub 10. Therein, the wheel hub 10 is especially suitable for an axle of a motor vehicle or truck, such as for axles of construction-site trucks and off-road vehicles or tipping trucks. A torque for a wheel (not shown) disposed on the axle is provided to a fixed inner hub 32 through an interior shaft 54. At an end opposing the drive assembly, the shaft 54 is operatively connected to a planetary gear 52. One recognizes that an outer hub 18 supports itself on the fixed inner hub 14 through taper roller bearings 56, 58. The outer hub 18 is connected to a brake housing 20 and constitutes an encapsulated housing with a space 22 for a multi-disk brake therewith. Therein, the encapsulated housing is formed in the interior such that circulation of a cooling fluid, especially oil, located therein occurs in the space 22. The multi-disk brake 12 is comprised of plural disk-shaped outer plates 16 and corresponding disk-shaped inner plates 14. Therein, the inner plates 14 constitute the fixed portion and the outer plates 16 constitute the rotating portion of the multi-disk brake 12, wherein the inner plates 14 are connected to the fixed inner hub 32 through a support member 30 in rotationally fixed and axially displaceable manner. The outer plates 16 are connected to radially outward, rotating outer hubs 18 in rotationally fixed and axially displaceable manner, wherein the outer plates 16 have radially outward recesses 68 engaging with plural bolts 34 axially attached between outer hub 18 and brake housing 20.

Further, one recognizes that a distribution space 36 is formed for the cooling fluid circulation between an inner side of the brake housing 20 and the bolts 34. Blade-like devices are peripherally formed between the inner plates 14 and the inner side of the brake housing 20, wherein the cooling fluid is pressed outwardly into the space 22 through the distribution space 36 by rotation of the blade-like devices and flows back again between the outer and inner plates 14, 16. In the illustrated embodiment, the inner plates 14 are provided with grooves on both sides. Further, the fixed inner plates 14 have at least partially a braking-promoting lining.

The multi-disk brake 12 is actuated through a pressurized piston. Therein, the pressurized piston 38 moves a brake plate 40 acting on a first inner plate 14, wherein a spring pack 42 is disposed in the piston 38. The spring pack 42 supports itself on an inner side of the piston 38 on the one hand and on a thrust plate 44 supported on the inner hub 32 on the other side. Upon pressurization of the piston 38, the spring pack 42 tensions, upon pressure release, it releases the tension. In the illustrated embodiment, the spring pack 42 is formed as a disk spring. Further, one recognizes that the brake plate 40 is connected to a brake cylinder 46 through a tension spring 48.

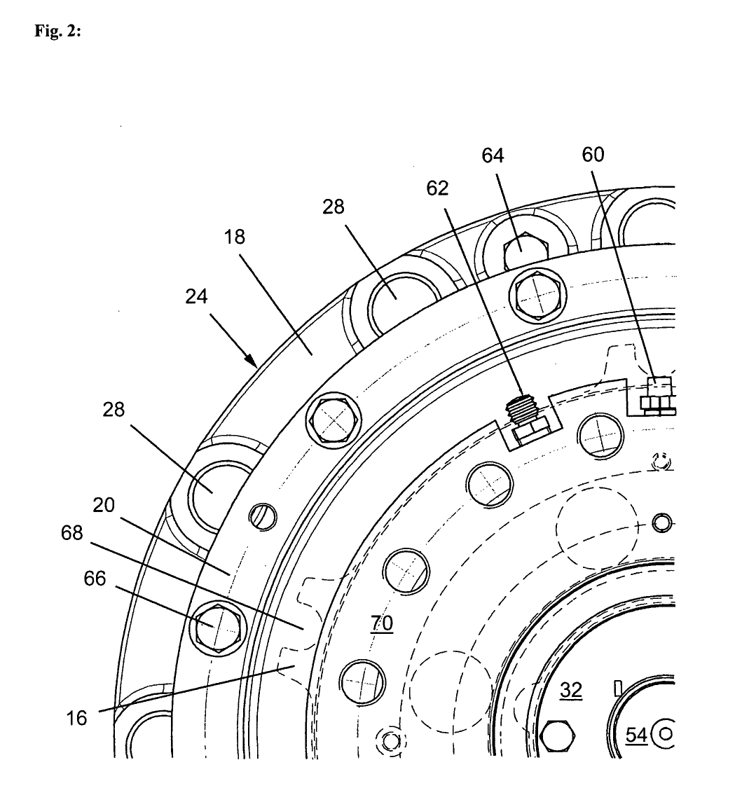

Additionally, the outer hub 18 has a surrounding collar 24 projecting outwards of the outer hub 18. Therein, plural openings 26 for respectively receiving a wheel bolt 28 for connecting the outer hub 18 to a rim of the wheel (not shown) are formed in the region of the collar 24. Additionally, the outer hub 18 is connected to a satellite cage 50 through plural connecting members 64 (compare also to FIG. 2). The outer hub 18 is sealingly connected to the brake housing 20 through plural connecting members 66. The wheel hub 10 additionally has a vent valve 60 for the space of the planetary gear 52 and the space for the multi-disk brake 12.

FIG. 2 shows a top view of a sub-portion of the wheel hub 10. One recognizes the surrounding collar 24 projecting outwardly of the outer hub 18. Therein, the collar 24 receives the wheel bolts 28 for connecting the outer hub 18 to a rim of the wheel. The brake housing 20 is connected to the outer hub 18 through the connecting members 66. Further, one recognizes in schematically illustrated manner the location of the outer plates 16 with the respectively outward recess 68 for receiving the bolts 34. Additionally, the wheel hub 10 has a bleeder valve 62 for the piston of the multi-disk brake 12 besides the vent 60 for the planetary gear 52.

Certain exemplary embodiments of the present invention are described above and illustrated in the attached Figures. The embodiments described are only for purposes of illustrating the present invention and should not be interpreted as limiting the scope of the invention. Other embodiments of the invention, and certain modifications and improvements of the described embodiments, will occur to those skilled in the art, and all such alternate embodiments, modifications and improvements are considered to be within the scope of the present invention.

1. A wheel hub for an axle of a motor vehicle or truck, especially for axles of construction-site trucks and off-road vehicles or tipping trucks, comprising
a multi-disk brake consisting of plural disk-shaped outer plates and corresponding disk-shaped inner plates as well as
an outer hub and
a brake housing which form an encapsulated housing with a space for the multi-disk brake, wherein the encapsulated housing is formed in the interior such that circulation of a cooling fluid located therein occurs in the space, wherein
the outer hub has an at least partially surrounding collar projecting outwardly of the outer hub, and wherein
plural openings for respectively receiving a wheel bolt for connecting the outer hub to a rim of a wheel are formed in the region of the collar, and that
a clearance improving the circulation of the cooling fluid is provided in the space between the outer plates and the outer hub.

2. A wheel hub according to claim 1, wherein said inner plates constitute the fixed portion and the outer plates constitute the rotating portion of the multi-disk brake, and wherein the inner plates are connected to a fixed inner hub through a supporting member in rotationally fixed and axially displaceable manner, and the outer plates are connected to the radially outward, rotating outer hub in rotationally fixed and axially displaceable manner, wherein the outer plates have radially outward recesses engaging with plural bolts axially attached between outer hub and brake housing.

3. A wheel hub according to claim 1, wherein a distribution space is formed for the cooling fluid circulation between an inner side of the brake housing and the bolts.

4. A wheel hub according to claim 2, wherein a distribution space is formed for the cooling fluid circulation between an inner side of the brake housing and the bolts.

5. A wheel hub according to claim 3, wherein blade-like devices are peripherally formed between the inner plates and the inner side of the brake housing, and wherein the cooling fluid is pressed outwardly into the space through the distribution space by rotation of the blade-like devices and flows back again between the outer and inner plates.

6. A wheel hub according to claim 4, wherein blade-like devices are peripherally formed between the inner plates and the inner side of the brake housing, and wherein the cooling fluid is pressed outwardly into the space through the distribution space by rotation of the blade-like devices and flows back again between the outer and inner plates.

7. A wheel hub according to claim 1, wherein the inner plates and/or the outer plates are at least partially provided with grooves on one side and/or both sides.

8. A wheel hub according to claim 2, wherein said fixed inner plates are at least partially provided with a braking-promoting lining.

9. Wheel hub according to claim 1, wherein a pressurized piston moves a brake plate acting on a first inner plate, wherein a spring pack is disposed in the piston, which supports itself on an inner side of the piston on the one hand and on a thrust plate supported on the inner hub on the other hand, such that the spring pack tensions upon pressurization of the piston and releases the tension upon pressure release.
